(19) United States
(12) Patent Application Publication
(10) Pub. No.: US 2007/0136569 A1
(43) Pub. Date: Jun. 14, 2007

(54) System and method for writing data onto a boot-up compact disc

(75) Inventors: Chang-Shun Li, Shenzhen (CN); Yong-Xing You, Shenzhen (CN); Ke-You Hu, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,912

(22) Filed: Oct. 27, 2006

(30) Foreign Application Priority Data
Dec. 6, 2005 (CN) 200510102321.3

(51) Int. Cl. G06F 9/00

(52) U.S. Cl. 713/2

(57) ABSTRACT

A method for writing data onto a boot-up compact disc includes the steps of: encoding an optional bootstrap program providing a plurality of boot-up functions; controlling a CD writer (13) to write the optional bootstrap program, drivers of a computer device and basic input output system (BIOS) codes (122) of the computer device onto the boot-up compact disc (15). A related system is also disclosed.

### FIELD OF THE INVENTION

The present invention generally relates to systems and methods for writing data, and more particularly to a system and method for writing data onto a boot-up compact disc.

### DESCRIPTION OF RELATED ART

With the fast development of computer devices, almost all of computer businesses in the world do their best to improve their computer-related products to increase their market share. As we are well aware, there is high competition on every computer products, such that significant market share can be gained no matter how small the improvement.

It is also well known that a boot-up compact disc has a huge storage capacity and is only configured for storing computer device drivers. Generally speaking, boot-up data in a boot-up compact disc occupies storage space proportionately small compared to the available/unused storage space of a boot-up compact disc, thus a huge surplus of storage space is wasted.

What is needed, therefore, is a system and method that writes data onto a boot-up compact disc, that can adequately utilize the huge surplus storage space of the boot-up compact disc, and further append attached functions onto the boot-up compact disc.

### SUMMARY OF THE INVENTION

A system for writing data onto a boot-up compact disc in accordance with a preferred embodiment includes a compact disc read-only memory (CD-ROM) configured for loading the boot-up compact disc, a compact disc (CD) writer connected with the CD-ROM; a storage device, and a writing module. The storage device is configured for storing drivers of a computer device and basic input output system (BIOS) codes of the computer device. The writing module includes an encoding sub-module, and a writing sub-module. The encoding sub-module is configured for encoding an optional bootstrap program providing a plurality of boot-up functions. The writing sub-module is configured for controlling the CD writer to write the optional bootstrap program, the drivers and the BIOS codes onto the boot-up compact disc.

A method for writing data onto a boot-up compact disc in accordance with a preferred embodiment includes the steps of: encoding an optional bootstrap program providing a plurality of boot-up functions; controlling a compact disc (CD) writer to write the optional bootstrap program, drivers of a computer device and basic input output system (BIOS) codes of the computer device onto the boot-up compact disc.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for writing data onto a boot-up compact disc in accordance with a preferred embodiment;

FIG. 2 is a schematic diagram of main function modules of a data writing module of FIG. 1; and

FIG. 3 is a flowchart of a method for writing data onto a boot-up compact disc by implementing the system of FIG. 1.

### DETAILED DESCRIPTION OF THE INVENTION

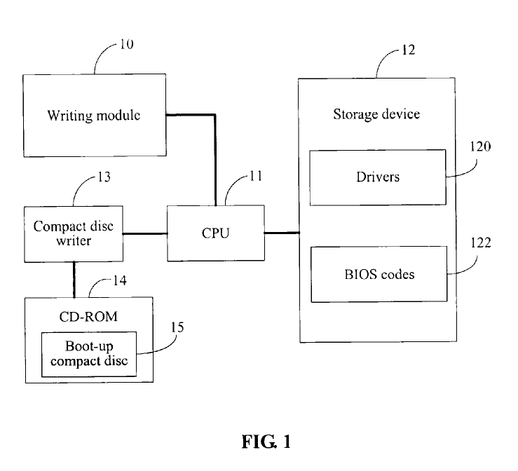

FIG. 1 is a schematic diagram of hardware configuration of a system for writing data onto a boot-up compact disc (hereinafter, “the system”) in accordance with a preferred embodiment. The system includes a writing module 10, a storage device 12, a compact disc read-only memory (CD-ROM) 14 configured for loading a boot-up compact disc 15, and a compact disc (CD) writer 13 connected with the CD-ROM 14. The storage device 12 is configured for storing drivers 120 of a computer and basic input output system (BIOS) codes 122 of the computer. The writing module 10 is configured for encoding an optional bootstrap program, and for controlling the CD writer 13 to write the optional bootstrap program, the drivers 120, and the BIOS codes 122 onto the boot-up compact disc 15. In the preferred embodiment, the storage device 12 can be a hard disk, a floppy disk, or any other suitable device.

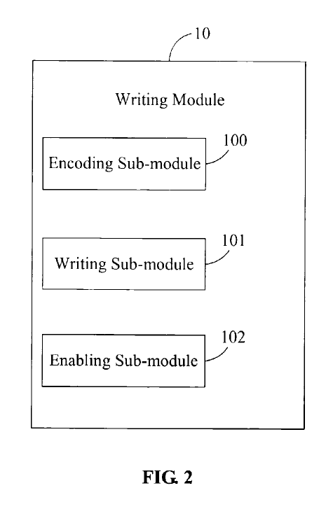

FIG. 2 is a schematic diagram of main function modules of the writing module 10. The writing module 10 typically includes an encoding sub-module 100, a writing sub-module 101, and an enabling sub-module 102.

The encoding sub-module 100 is configured for encoding an optional bootstrap program that provides a plurality of boot-up functions. In the preferred embodiment, the optional bootstrap program includes a boot-up interface generating program and a batch program for refreshing the BIOS codes 122. The batch program can be encoded, for example, as follows:

Recover BIOS: awdflash.exe

BIOS.bin/cc/cd/py/sn/wb/f/e

The “awdflash.exe” denotes an executable program for refreshing the BIOS codes 122.

The boot-up interface generating program is encoded by integrating the batch program and utilizing a general interface generating software named “Boot easy”. The boot-up interface generating program is used for generating a boot-up interface with four boot-up options: refreshing the BIOS codes 122; enabling an operating system of the computer; booting the computer from a hard disk; and rebooting the computer.

In other words, the encoding sub-module 100 provides an operational interface for a user to encode the batch program, and provides another operational interface for the user to encode the boot-up interface generating program by utilizing the “Boot easy”.

The writing sub-module 101 is configured for controlling the CD writer 13 to write needed data onto the boot-up compact disc 15. In the preferred embodiment, the needed data includes the optional bootstrap program, the drivers 120, and the BIOS codes 122.

The enabling sub-module 102 is configured for enabling the boot-up compact disc after the CD writer 13 writes the data onto the boot-up compact disc 15. In the preferred embodiment, the enabling sub-module 102 reboots the computer 1, selects a BIOS setting option named “Motherboard BIOS setup”, and enables the boot-up compact disc 15 by setting a startup mode, such as setting the First Boot device as a CD-ROM.

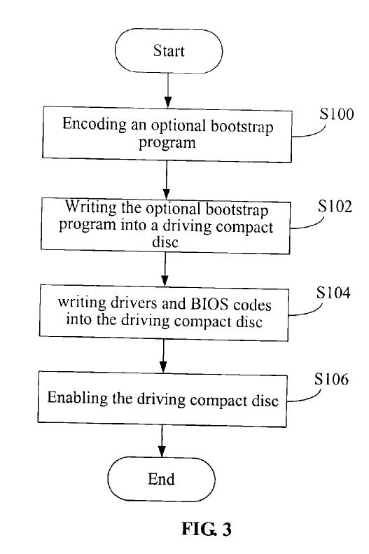

FIG. 3 is a flowchart of a method for writing data onto a boot-up compact disc by implementing the system of FIG. 1. In step S100, the encoding sub-module 100 encodes an optional bootstrap program that provides the four boot-up functions: refreshing the BIOS codes 122; enabling an operating system of the computer; booting the computer from a hard disk; and rebooting the computer. In step S102, the writing sub-module 101 controls the CD writer 13 to write the optional bootstrap program onto the boot-up compact disc 15. In step S104, the writing sub-module 101 controls the CD writer 13 to write the drivers 120 and the BIOS codes 122 onto the boot-up compact disc 15. In step S106, the enabling sub-module 102 reboots the computer 1, enables the BIOS setting option named “Motherboard BIOS setup”, and enables the boot-up compact disc 15 by setting a startup mode, such as setting the First Boot device as the CD-ROM 14.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for writing data onto a boot-up compact disc, the system comprising:
a compact disc read-only memory (CD-ROM) configured for loading the boot-up compact disc;
a compact disc (CD) writer connected with the CD-ROM;
a storage device configured for storing drivers of a computer device and basic input output system (BIOS) codes of the computer device; and
a writing module comprising:
an encoding sub-module configured for encoding an optional bootstrap program providing a plurality of boot-up functions; and
a writing sub-module configured for controlling the CD writer to write the optional bootstrap program, the drivers, and the BIOS codes onto the boot-up compact disc.

2. The system as claimed in claim 1, wherein the writing module further comprises: an enabling sub-module configured for enabling the boot-up compact disc by setting a startup mode after the CD writer writes the data onto the boot-up compact disc.

3. The system as claimed in claim 1, wherein the boot-up functions comprise:
refreshing the BIOS codes of the computer device;
enabling an operating system of the computer device;
booting the computer device from a hard disk; and
rebooting the computer device.

4. A method for writing data onto a boot-up compact disc, the method comprising the steps of:
encoding an optional bootstrap program providing a plurality of boot-up functions;
controlling a compact disc (CD) writer to write the optional bootstrap program, drivers of a computer device and basic input output system (BIOS) codes of the computer device onto the boot-up compact disc.

5. The method as claimed in claim 4, further comprising the step of:
enabling the boot-up compact disc by setting a startup mode after the CD writer writes the data onto the boot-up compact disc.

6. The method as claimed in claim 4, wherein the boot-up functions comprise:
refreshing the BIOS codes of the computer device;
enabling an operating system of the computer device;
booting the computer device from a hard disk; and
rebooting the computer device.
